(19) United States
(12) Patent Application Publication
(10) Pub. No.: US 2025/0031711 A1
(43) Pub. Date: Jan. 30, 2025

(54) YOGURT CRUMBLE COMPOSITIONS AND METHODS OF MANUFACTURING

(71) Applicant: Sergey Konchakovskiy, Holmdel, NJ (US)

(72) Inventor: Sergey Konchakovskiy, Holmdel, NJ (US)

(21) Appl. No.: 18/774,693

(22) Filed: Jul. 16, 2024

Related U.S. Application Data
(60) Provisional application No. 63/516,522, filed on Jul. 30, 2023.

(51) Int. Cl. A23C 9/127; A23C 9/13

(52) U.S. Cl. CPC A23C 9/127; A23C 9/1307; A23C 9/1315

(57) ABSTRACT

The embodiments herein are directed to systems, methods, and compositions for yogurt crumbles. These dehydrated yogurt crumbles retain all the essential properties of yogurt in various forms, including drinkable, spoonable, or snackable varieties. The methods described herein yield yogurt crumbles suitable for a range of culinary applications, such as topping salads or pizzas, and serving as versatile cooking or baking ingredients. Additionally, the process accommodates the incorporation of diverse flavors and enhancements through the utilization of food additives such as spices, salt, sugar, oils, fats, fruits, vegetables, meats, and cheeses. Furthermore, the resulting yogurt crumbles can be conveniently packaged for retail distribution using standard packaging methodologies.

### INCORPORATION BY REFERENCE TO ANY PRIORITY APPLICATIONS

This application claims the priority benefit under 35 U.S.C. § 119 (e) of U.S. Provisional Application No. 63/516,522, filed Jul. 30, 2023, the entire disclosure of which is incorporated herein by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure relates to the field of field of food products, specifically to dairy-based or alternative dairy-based food products.

### Description

Within the field of dairy-based or alternative dairy-based food products, particularly yogurt products, there have been various attempts to enhance consumer experience by incorporating additional textures and flavors. One common approach has been the addition of fruit purees, syrups, and/or granola. These combinations aim to provide a more enjoyable eating experience by adding contrasting textures and flavors to the smooth, creamy consistency of yogurt.

For example, there are existing yoghurt products with a fruit layer at the bottom of the container, designed to be mixed with the yogurt by the consumer. Other examples include products incorporating granola into yogurt. The granola is typically packaged separately from the yoghurt to prevent it from becoming soggy, allowing consumers to add it to the yogurt just before consumption.

While these products have added variety in flavor and texture to yogurt products, they often face challenges such as maintaining the desired texture of the added components over the product's shelf life. Granola, for instance, can quickly lose its crunchiness when stored with yogurt, leading to a less satisfying texture. As such, these products require the consumer to combine the products at the time of consumption. The separation of components like granola or fruit from yogurt can be inconvenient for consumers and adds to the complexity and cost of production.

The present invention seeks to address these limitations by providing an improved product in an all-in-one package. Unlike prior products, the present invention comprises a novel and unique formulation and method of combining a dairy or alternative dairy component with a texture/flavor component in a way that preserves the texture and consistency of the product until consumption.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or conducted in a manner that achieves one advantage or group of advantages as taught herein without necessarily achieving other advantages as may be taught or suggested herein.

Some embodiments herein are directed to a yoghurt composition comprising: dehydrated whole milk, low-fat, or non-fat yoghurt comprising at least 40% solids by weight and at least 20% protein by weight, wherein the dehydrated yoghurt is formed into crumbles that have a solid texture, wherein at least 85% of the crumbles comprise a diameter between about 0.125 inch to about 0.750 inch.

In some embodiments, the dehydrated yoghurt comprises Streptococcus salivarius thermophilus and/or Lactobacillus delbruekii subsp. Bulgaricus.

In some embodiments, the yogurt composition further comprises a flavor component comprising at least one of the following: vanilla, strawberry, blueberry, raspberry, peach, mango, coconut, lemon, lime, cherry, banana, apple, pineapple, orange, blackberry, cranberry, pomegranate, passion fruit, kiwi, grape, watermelon, honeydew, cantaloupe, apricot, fig, plum, grapefruit, guava, lychee, papaya, elderberry, boysenberry, loganberry, mulberry, tangerine, mandarin, nectarine, pear, star fruit, persimmon, dragon fruit, durian, melon, pumpkin, squash, sweet potato, yam, carrot, beetroot, parsnip, radish, turnip, rutabaga, kohlrabi, celery, fennel, leek, onion, shallot, garlic, chive, scallion, mushroom, truffle, bell pepper, chili pepper, jalapeño, habanero, cayenne, paprika, black pepper, white pepper, green pepper, red pepper, yellow pepper, orange pepper, pink pepper, lemon pepper, lime pepper, peppercorn, mustard, Dijon mustard, wholegrain mustard, honey mustard, spicy mustard, horseradish, wasabi, ginger, cinnamon, nutmeg, clove, allspice, cardamom, star anise, chocolate, cocoa, coffee, caramel, toffee, butterscotch, maple, honey, molasses, agave, almond, hazelnut, pecan, walnut, cashew, macadamia, pistachio, peanut, sesame, sunflower, pumpkin seed, flaxseed, chia seed, poppy seed, quinoa, amaranth, millet, barley, oats, rye, spelt, wheat, rice, corn, sorghum, teff, buckwheat, lentil, chickpea, pea, bean, mung bean, kidney bean, black bean, soybean, tofu, tempeh, miso, natto, seaweed, nori, wakame, kombu, hijiki, dulse, spirulina, chlorella, agar, konjac, psyllium, xanthan gum, guar gum, carrageenan, pectin, gelatin, bee pollen, royal jelly, propolis, bee venom, honeycomb, and beeswax.

In some embodiments, the yogurt composition further comprises at least one of the following functional ingredients: collagen, whey protein, casein protein, pea protein, hemp protein, rice protein, pumpkin protein, cricket protein, insect protein, mealworm protein, ant protein, probiotics, prebiotics, fiber, omega-3 fatty acids, antioxidants, vitamins, minerals, calcium, potassium, magnesium, iron, zinc, selenium, vitamin A, vitamin C, vitamin D, vitamin E, vitamin K, vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folate), vitamin B12 (cobalamin), electrolytes, amino acids, protein, carbohydrates, fat, cholesterol, lactose, casein, whey, lactalbumin, lactoglobulin, immunoglobulins, lactoferrin, lactoperoxidase, lysozyme, lactulose, lactitol, lactase, lactase enzyme, lactase prebiotic, lactase probiotic, lactase supplement, lactoferrin supplement, inulin, fructooligosaccharides (FOS), galactooligosaccharides (GOS), resistant starch, arabinoxylan, beta-glucans, chitin, chitosan, psyllium, and oat fiber.

In some embodiments, the dehydrated yoghurt comprises dehydrated whole milk yogurt, wherein the whole milk yoghurt comprises a fat content of at least 3.5%, and a pH of 4.8 or less. In some embodiments, the dehydrated yoghurt comprises dehydrated low-fat or non-fat yoghurt, wherein the low-fat or non-fat yoghurt comprises a fat content of less than 3.5%, and a pH of 4.8 or less.

Some embodiments herein are directed to methods of manufacturing a yoghurt composition, the method comprising: feeding whole milk, low-fat, or non-fat yoghurt into a filtering bag; placing the filtering bag into a cheese press and applying pressure to the filtering bag until a solid content of the yoghurt is at least 40% to form dehydrated yoghurt; processing the dehydrated yogurt in a cheese crumbler or a cheese shredder to produce dehydrated yoghurt crumbles; and applying an anti-caking agent to the dehydrated yoghurt crumbles.

In some embodiments, the anti-caking agent comprises silicon dioxide (silica), calcium silicate, magnesium stearate, sodium aluminosilicate, or tricalcium phosphate. In some embodiments, the yoghurt comprises whole milk yogurt, wherein the whole milk yoghurt comprises a fat content of at least 3.5%, and a pH of 4.8 or less. In some embodiments, the yoghurt comprises low-fat or non-fat yoghurt, wherein the low-fat or non-fat yoghurt comprises a fat content of less than 3.5%, and a pH of 4.8 or less.

In some embodiments, the method further comprises adding one or more of a flavor component, a functional ingredient, and/or a supplemental fat source to the yoghurt.

In some embodiments, the pressure is applied to the filtering bag in the cheese press for about 8 hours to about 18 hours at a pressure of about 1 Bar to about 10 Bar.

Some embodiments herein are directed to methods a non-fat yoghurt composition, the method comprising: feeding non-fat yoghurt into a food certified decanter centrifuge at a temperature of about 60° F. to about 115° F.; centrifuging the non-fat yoghurt at a bowl speed of about 2500 rpm to about 4900 rpm and a pressure of about 1 Bar to about 2 Bar until a solid content of the non-fat yoghurt is at least 40% by weight to form dehydrated non-fat yoghurt; processing the dehydrated non-fat yogurt in a cheese crumbler or a cheese shredder to produce dehydrated non-fat yoghurt crumbles; and applying an anti-caking agent to the dehydrated yoghurt crumbles.

In some embodiments, the anti-caking agent comprises silicon dioxide (silica), calcium silicate, magnesium stearate, sodium aluminosilicate, or tricalcium phosphate. In some embodiments, the non-fat yoghurt comprises a fat content of less than 3.5%, and a pH of 4.8 or less.

In some embodiments, the method further comprises adding one or more of a flavor component, a functional ingredient, and/or a supplemental fat source to the yoghurt.

Some embodiments herein are directed to methods of manufacturing a yoghurt composition, the method comprising: feeding yoghurt into a food certified decanter centrifuge at a temperature of about 60° F. to about 115° F.; centrifuging the yoghurt at a bowl speed of about 2500 rpm to about 4900 rpm and a pressure of about 1 Bar to about 2 Bar; measuring a solid content of the yoghurt after a predetermined period of time; if the solid content of the yoghurt is less than 40% by weight, feeding the yoghurt into a filtering bag; placing the filtering bag into a cheese press and applying pressure to the filtering bag until a solid content of the yoghurt is at least 40% to form dehydrated yoghurt; processing the dehydrated yogurt in a cheese crumbler or a cheese shredder to produce dehydrated yoghurt crumbles; and applying an anti-caking agent to the dehydrated yoghurt crumbles.

In some embodiments, the yoghurt comprises non-fat yoghurt, wherein the non-fat yoghurt comprises a fat content of less than 3.5%, and a pH of 4.8 or less. In some embodiments, the anti-caking agent comprises silicon dioxide (silica), calcium silicate, magnesium stearate, sodium aluminosilicate, or tricalcium phosphate.

In some embodiments, the method further comprises adding one or more of a flavor component, a functional ingredient, and/or a supplemental fat source to the yoghurt.

Although several configurations, examples, and illustrations are disclosed below, it will be understood by those of ordinary skill in the art that the disclosure extends beyond the specifically disclosed configurations, examples, and illustrations and includes other uses of the disclosure. Configurations are described with reference to the accompanying figures, wherein like numerals refer to like elements throughout. The terminology used in the description presented herein is not intended to be interpreted in any limited or restrictive manner simply because it is being used in conjunction with a detailed description of some specific configurations of the disclosure. In addition, configurations can comprise several novel and inventive features. No single feature is solely responsible for its desirable attributes or is essential to practicing the disclosure herein described.

### BRIEF DESCRIPTION OF THE DRAWINGS

Throughout the drawings, reference numbers may be reused to indicate general correspondence between referenced elements. The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates a diagram of an example filter bag dehydrating process according to some embodiments herein.

FIG. 2 illustrates a diagram of an example decanter centrifugal dehydrating process according to some embodiments herein.

FIG. 3 illustrates a diagram of an example decanter centrifugal dehydrating process and supplemental bag pressing according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be conducted in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Presently, there are many crumbled food products that are typically used as ingredients, additives, or enhancers for more complex foods. Among these products, cheese crumbles or crumbled cheese play a significant role in human nutrition. These include many products such as feta crumbles, blue cheese crumbles, cheddar crumbles, among others. Generally, cheese crumbles contain a significant amount of fats and salt, while lacking probiotics. For health-conscious consumers seeking to avoid specific dietary components such as unhealthy fats, salt, sodium, and/or high calorie density, these options may not always align with their nutritional goals. Similarly, individuals in pursuit of higher protein intake, lower calorie consumption, and the inclusion of gut-health probiotics may find the existing offerings lacking in suitability. This highlights a gap in the market for a more health-conscious alternative to crumbled cheeses, primarily feta cheese crumbles. One objective of the present invention is to produce an alternative to such cheese crumbles in the form of a yogurt crumble product (e.g., yogurt crumbles or crumbled yogurt), which caters to the preferences and requirements of consumers striving for balanced and nutritious dietary choices. In comparison with various cheese crumbles, yogurt crumbles as described herein may be low fat or fat free, relatively low in caloric density, contain higher protein and large counts of live probiotics, and do not contain salt or sodium.

In some embodiments, the present invention relates to yogurt crumbles: a novel non-viscous form of yogurt that can be used as a topping, snack, or ingredient in various culinary applications. In some embodiments, the product is derived from traditional yogurt but offers a completely unique texture and usage. Traditional yogurt is widely recognized for its creamy and viscous texture, which limits its culinary applications to being a spoonable or drinkable product. Despite yogurt's popularity and nutritional benefits, there has been no innovation that transforms its physical form to expand its versatility. The present invention addresses this gap by providing a product that retains and enhances the health benefits of yogurt while introducing a completely new texture and application potential. In some embodiments, provided are compositions and methods for yogurt crumbles that are distinctly non-viscous. In some embodiments, the yoghurt crumbles have a higher protein content, no added salt, and contain a substantial amount of beneficial lactic bacteria. The specific size range of the crumbles ensures a consistent and desirable texture. In some embodiments, this novel form factor and texture, combined with the health benefits of yoghurt, makes yogurt crumbles truly unparalleled in the market.

As noted above, unlike any traditional yogurt product, yogurt crumbles offer a solid, crumbly texture, opening up new culinary applications. Furthermore, with a minimum of protein content of at least 20%, yogurt crumbles according to the embodiments herein provide a superior nutritional profile compared to traditional yogurt. The absence of added salt and enhanced digestive health benefits provided by lactic bacteria supports health-conscience consumers. Additionally, the specific crumble size allows for diverse culinary uses, making yoghurt crumbles suitable for toppings, snacks, and ingredients in various dishes. The invention of yogurt crumbles represents a significant breakthrough in the yogurt industry. By transforming the traditional viscous yogurt into a non-viscous, solid form, this product offers unparalleled versatility and nutritional benefits. There is no existing product in the market that compares to the unique characteristics and applications of yogurt crumbles.

In some embodiments, the systems, methods, and compositions described herein may be used in a variety of applications, including a novel range of salad toppings and cheese alternatives in crumbled form, specifically tailored to meet the demands of health-conscious consumers. Other applications for the crumbled yoghurt products described herein include, for example, crumbled yoghurt parfaits, smoothie toppers, baked goods, frozen yoghurt toppings, yoghurt bark, stuffed fruits, energy bites, yoghurt dips, breakfast bars, and desserts, among others. For example, there are a plethora of salad toppings and dairy/non-dairy cheese-based food ingredients are readily available in crumbled form. Prominent among these offerings are cheese crumbles like feta and blue cheese, which enjoy widespread popularity. However, for health-conscious consumers seeking to avoid specific dictary components such as fats, salt, sodium, and high calorie counts, these options may not always align with their nutritional goals. Similarly, individuals in pursuit of higher protein intake, lower calorie consumption, and the inclusion of gut-health probiotics may find the existing offerings lacking in suitability. This highlights a gap in the market for a more health-conscious alternative to crumbled cheeses, primarily feta cheese crumbles. The embodiments herein provide an alternative that caters to the preferences and requirements of consumers striving for balanced and nutritious dietary choices. Thus, in some embodiments, the compositions described herein comprise a novel range of salad toppings and cheese alternatives in crumbled form, specifically tailored to meet the demands of health-conscious consumers.

In some embodiments, yogurt crumble(s) as described herein may comprise a yogurt component. In some embodiments, the yoghurt component may be a yoghurt as described by the Food and Drug Administration's Standard of Identity for Yogurt (21 CFR Part 131.200). Straining yogurt partially to remove liquid is a familiar procedure known as separation, but a process of dehydrating yogurt to a degree that enables the creation of a novel food item, yogurt crumbles, is unprecedented and distinctive. Embodiments of the present invention include a manufacturing process for yogurt crumbles, encompassing practical techniques for creating a palatable yogurt base and dehydrating the base to yield a brittle mass that can be further broken down into crumbles. In some embodiments, these dehydrated yogurt crumbles retain all the essential properties of yogurt in various forms, including drinkable, spoonable, or snackable varieties. In some embodiments, the methods described herein yield yogurt crumbles suitable for a range of culinary applications, such as topping salads or pizzas, and serving as versatile cooking or baking ingredients. Additionally, the processes described herein accommodate the incorporation of diverse flavors and enhancements through the utilization of food additives such as spices, salt, sugar, oils, fats, fruits, vegetables, meats, and cheeses. Furthermore, the resulting yogurt crumbles can be conveniently packaged for retail distribution using standard packaging methodologies.

As used herein, the term “yogurt” (or “yoghurt”, the terms are used interchangeably herein) refers to products comprising lactic acid bacteria such as Streptococcus salivarius thermophilus and Lactobacillus delbruekii subsp. bulgaricus, but also, optionally, other microorganisms such as Lactobacillus delbruekii subsp. lactis, Bifidobacterium animalis subsp. lactis, Lactococcus lactis, Lactobacillus acidophilus and Lactobacillus casei, or any microorganism derived therefrom. In some embodiments, the lactic acid strains other than Streptococcus salivarius thermophilus and Lactobacillus delbruekii subsp. bulgaricus, are intended to give the finished product various properties, such as the property of promoting the equilibrium of the gut microbiota. In some embodiments, the yoghurt component may comprise traditional yoghurt made from animal milk (e.g., cow's milk), Greek yoghurt, French yoghurt, Icelandic Skyr, Balkan Yoghurt, Labneh, Kefir, Filmjölk, Ayran, Lassi, plant-based yoghurt, soy yoghurt, almond yoghurt, buttermilk, sour cream, coconut yoghurt, cashew yoghurt, oat yoghurt, hemp yoghurt, nut yoghurt, or rice yoghurt, among others.

The term “yogurt” encompasses, but is not limited to, yoghurt as defined according to French and European regulations, e.g. coagulated dairy products obtained by lactic acid fermentation by means of specific thermophilic lactic acid bacteria only (i.e. Lactobacillus delbruekii subsp. bulgaricus and Streptococcus salivarius thermophilus) which are cultured simultaneously and are found to be live in the final product in an amount of at least 10 million CFU (colony-forming unit)/g. Preferably, the yogurt is not heat-treated after fermentation. Such yogurt advantageously meets the specifications for fermented milks and yogurts of the AFNOR NF 04-600 standard and/or the codex StanA-IIa-1975 standard. In order to satisfy the AFNOR NF 04-600 standard, the product must not have been heated after fermentation and the dairy raw materials must represent a minimum of 70% (m/m) of the finished product. However, in some embodiments, the term “yoghurt” also encompasses non-dairy or alternative dairy yoghurts.

Thus, the systems, methods, and compositions described herein pertain to dairy-based or alternative dairy-based food products. In some embodiments, the food products also comprise a crumble, designed to enhance texture, flavor, and overall consumer experience of the food products. The systems, methods, and compositions described herein encompass formulations and methods of preparation that maintain the integrity of the crumble ensuring optimal taste and texture for consumption. The most important parameter that differentiates yogurt crumbles from traditional yogurt is the non-viscous nature of the crumbles. The viscosity of all yogurts, including traditional forms, can be measured using a viscometer. In contrast, yogurt crumbles as described herein are manufactured to have a solid, crumbly texture. Furthermore, in some embodiments, the protein content in yogurt crumbles is at least about 20% by weight, which is significantly higher than traditional yogurt, which typically has a protein content ranging from 10% to a maximum of 12%. For example, in some embodiments, the yoghurt crumbles may comprise a protein content of at least about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, or any value between the aforementioned values. Furthermore, yogurt crumbles as described herein may comprise no added salt, making them a healthier alternative for those monitoring their sodium intake. In some embodiments, the yogurt crumbles contains at least 10 million colony-forming units (CFU) of lactic bacteria per 100 g, ensuring probiotic benefits similar to those of traditional yogurt. Additionally, in some embodiments, the yogurt crumbles are sized to ensure that at least 85% of the crumbles have a diameter between about ⅛ inch to about ¾ inch. For example, in some embodiments, at least 85% of the crumbles have a diameter between about 0.125 inch, about 0.15 inch, about 0.175 inch, about 0.2 inch, about 0.225 inch, about 0.25 inch, about 0.275 inch, about 0.3 inch, about 0.325 inch, about 0.35 inch, about 0.375 inch, about 0.4 inch, about 0.425 inch, about 0.45 inch, about 0.475 inch, about 0.5 inch, about 0.525 inch, about 0.55 inch, about 0.575 inch, about 0.6 inch, about 0.625 inch, about 0.65 inch, about 0.675 inch, about 0.7 inch, about 0.725 inch, about 0.75 inch, or any value between the aforementioned values. In some embodiments, this specific size range provides a consistent texture and appearance suitable for various applications. Table 1 illustrates example analytical test results summarizing nutrition information for a 100 g sample of yoghurt crumbles according to some embodiments herein.

TABLE 1

| Parameter | Result |
|---|---|
| Calories | 119 |
| Total Carbohydrates | 5.73 |
| Calcium | 95.7 |
| Iron | ND |
| Potassium | 171 |
| Sodium | 30.2 |
| Ash | 1.13 |
| Moisture | 69.6 |
| Total Sugar | 1.47 |
| Total Dietary Fiber | ND |
| Protein | 23.1 |
| Cholesterol | 10.1 |
| Total Fat | 0.44 |
| Saturated Fat | 0.33 |
| Polyunsaturated Fat | ND |
| Monounsaturated Fat | 0.11 |
| Trans Fat | ND |

*ND - indicates that the analyte was not detected at the limit of quantitation

In some embodiments, yogurt crumbles as described herein may comprise a distinctive taste and mouthfeel that is instantly recognizable and widely appreciated by consumers. In some embodiments, the flavor may be characterized by a tart profile, with subtle hints of acidity and creaminess. In some embodiments, the texture of the yoghurt crumbles may be simultaneously creamy and crumbly, offering a satisfying contrast that enhances the overall culinary experience. As the yoghurt crumbles dissolve on the palate, they leave behind a lingering sensation of creamy tartness. In some embodiments, the taste and mouthfeel of yogurt crumbles contribute a unique and delightful dimension to a wide range of dishes, from salads to pastas.

In some embodiments, yogurt crumbles may be prepared plain without any additional flavor components. However, in some embodiments, additional flavor components may be added. For example, in some embodiments, traditional sweet flavors such as vanilla, fruits, or honey may be used. In some embodiments, these sweet-flavored yogurt crumbles offer a delightful balance of creamy sweetness, perfect for sprinkling over fruit salads, oatmeal, or desserts like ice cream or yogurt parfaits. Conversely, in some embodiments, savory flavors like garlic, herbs, or spices can provide a savory twist to yogurt crumbles, making them ideal for savory dishes like salads, wraps, or baked potatoes. In some embodiments, these savory variations add depth and complexity to recipes, elevating their flavor profile and versatility. Furthermore, in some embodiments, exotic and innovative flavor combinations, such as mango chili, matcha green tea, or coconut lime, catering to adventurous palates and culinary trends may be utilized. These unique flavor profiles can help differentiate yogurt crumbles, appealing to consumers seeking novel and memorable taste experiences.

In some embodiments, one or more flavor components may be used, for example, vanilla, strawberry, blueberry, raspberry, peach, mango, coconut, lemon, lime, cherry, banana, apple, pineapple, orange, blackberry, cranberry, pomegranate, passion fruit, kiwi, grape, watermelon, honeydew, cantaloupe, apricot, fig, plum, grapefruit, guava, lychee, papaya, elderberry, boysenberry, loganberry, mulberry, tangerine, mandarin, nectarine, pear, star fruit, persimmon, dragon fruit, durian, melon, pumpkin, squash, sweet potato, yam, carrot, beetroot, parsnip, radish, turnip, rutabaga, kohlrabi, celery, fennel, leck, onion, shallot, garlic, chive, scallion, mushroom, truffle, bell pepper, chili pepper, jalapeño, habanero, cayenne, paprika, black pepper, white pepper, green pepper, red pepper, yellow pepper, orange pepper, pink pepper, lemon pepper, lime pepper, peppercorn, mustard, Dijon mustard, wholegrain mustard, honey mustard, spicy mustard, horseradish, wasabi, ginger, cinnamon, nutmeg, clove, allspice, cardamom, star anise, chocolate, cocoa, coffee, caramel, toffee, butterscotch, maple, honey, molasses, agave, almond, hazelnut, pecan, walnut, cashew, macadamia, pistachio, peanut, sesame, sunflower, pumpkin seed, flaxseed, chia seed, poppy seed, quinoa, amaranth, millet, barley, oats, rye, spelt, wheat, rice, corn, sorghum, teff, buckwheat, lentil, chickpea, pea, bean, mung bean, kidney bean, black bean, soybean, tofu, tempeh, miso, natto, seaweed, nori, wakame, kombu, hijiki, dulse, spirulina, chlorella, agar, konjac, psyllium, xanthan gum, guar gum, carrageenan, pectin, gelatin, bee pollen, royal jelly, propolis, bee venom, honeycomb, and beeswax, among others.

Moreover, in some embodiments, the yoghurt crumbles may comprise one or more functional ingredients such as proteins, superfoods, or natural extracts can enhance the nutritional value of flavored yogurt crumbles, aligning them with the growing demand for functional foods that promote health and wellness. For example, in some embodiments, the one or more functional ingredients may comprise collagen, whey protein, casein protein, pea protein, hemp protein, rice protein, pumpkin protein, cricket protein, insect protein, mealworm protein, ant protein, probiotics, prebiotics, fiber, omega-3 fatty acids, antioxidants, vitamins, minerals, calcium, potassium, magnesium, iron, zinc, selenium, vitamin A, vitamin C, vitamin D, vitamin E, vitamin K, vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folate), vitamin B12 (cobalamin), electrolytes, amino acids, protein, carbohydrates, fat, cholesterol, lactose, casein, whey, lactalbumin, lactoglobulin, immunoglobulins, lactoferrin, lactoperoxidase, lysozyme, lactulose, lactitol, lactase, lactase enzyme, lactase prebiotic, lactase probiotic, lactase supplement, lactoferrin supplement, inulin, fructooligosaccharides (FOS), galactooligosaccharides (GOS), resistant starch, arabinoxylan, beta-glucans, chitin, chitosan, psyllium, and oat fiber, among others.

### Manufacturing Process

In some embodiments, the yoghurt crumbles are prepared via a process of dehydrating yogurt into a dehydrated yogurt mass comprising a non-viscous, non-sticky compound with a dense, brittle, and crumbly texture. Some embodiments include dehydrating yogurt to a degree that enables the creation of distinctive yogurt crumbles in which a palatable yogurt base is dehydrated to yield a brittle mass that can be further broken down into the crumbles. In some embodiments, the dehydrated yogurt mass comprises between about 45% to about 75% moisture and about 25% to about 55% of total solids by weight. In some embodiments, the dehydrated yogurt mass may be derived from tank-set yogurt, whether strained or not, utilizing a variety of separation, pressing, and co-pressing techniques detailed below. Further processing includes yogurt dehydrating to a solid content of at least 40%, crumbling, anti-caking, and retail packaging.

Tank-set yogurt is a type of yogurt-making process that involves fermenting the yogurt in large tanks rather than individual containers. In this method, the yogurt mixture is prepared and then transferred into a tank for fermentation. The tanks are temperature-controlled to create the ideal environment for the growth of beneficial bacteria, which ferment the milk and produce yogurt.

In some embodiments, the dehydrated yogurt mass comprises between about 45% to about 75% moisture by weight. In some embodiments, the dehydrated yoghurt mass comprises a weight percent of moisture of about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, or any value between the aforementioned values.

In some embodiments, the dehydrated yogurt mass comprises between about 25% to about 55% total solids by weight. In some embodiments, the dehydrated yogurt mass comprises a weight percent of solids of about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, or any value between the aforementioned values.

In some embodiments, the yogurt utilized in producing the dehydrated yogurt mass may adhere to the standards outlined by the Food and Drug Administration's Standard of Identity for Yogurt (21 CFR Part 131.200). In some embodiments, this may include the use of whole milk, low-fat, or non-fat yogurt. In other embodiments, a different dairy or alternative dairy yoghurt component may be utilized.

In some embodiments, whole milk yogurt may be utilized, wherein the whole milk yoghurt comprises a minimum starting total solids content of 11.25%, a minimum fat content of 3.5%, and a pH of 4.8 or less. In some embodiments, low-fat and non-fat milk yogurt may be utilized, the low-fat or non-fat yoghurt comprising non-fat solids of at least 8.25%, a fat content less than 3.5%, and a pH less than 4.8. In some embodiments, the low-fat or non-fat yoghurt may comprise a pH of about 3.9 to about 4.7.

In some embodiments, to enhance the output of the dehydrated yogurt mass during the subsequent separation, pressing, and co-pressing processes, the initial fresh or reconstructed milk (whether whole, low-fat, or non-fat), called the pre-pasteurization fluid, may be fortified with dairy-derived or alternative dairy powders. These powders, derived from milk or dairy foods or alternative dairy, can include, for example, yogurt powder, milk powder, calcium cascinate, whey protein concentrate, lactose powder, casein protein powder, dairy creamer powder, butter powder, cheese powder, whey protein isolate, cream powder, and/or various combinations thereof. In some embodiments, the dairy-derived or alternative dairy powders may also provide flavor, texture, nutritional value, and functionality to the final product.

In some embodiments, fortification of the pre-pasteurization fluid fresh or reconstructed milk with dairy-derived or alternative dairy powders may comprise fortifying with powder up to about 30% of the weight of the fluid fresh or reconstructed milk. In some embodiments, the fortification process involves adding the dairy-derived powders directly to the fluid fresh or reconstructed milk and allowing sufficient time for full rehydration of the powder. In some embodiments, the pre-pasteurization fluid (made from water and milk solids), is prepared and heated to the desired temperature for pasteurization. Before pasteurization, the pre-pasteurization may be adjusted for fat content, solids content, and other factors to meet product specifications. In some embodiments, the dairy-derived or alternative dairy powders may be added to the pre-pasteurization fluid in predetermined quantities. In some embodiments, the powders may be added directly to the fluid and then mixed thoroughly to ensure uniform distribution. In some embodiments, the amount of fortification depends on the desired nutritional content and functional properties of the final product, as well as regulatory requirements. In some embodiments, mold and/or yeast preservatives may be added as needed to the pre-pasteurization fluid prior to pasteurization.

In some embodiments, a pasteurization process may be conducted to convert the pre-pasteurization fluid into yoghurt. In some embodiments, the yogurt may be processed in accordance with Current Good Manufacturing Practices (21 CFR Part 110). In some embodiments, the pasteurization process involves heating the fluid to a specific temperature for a set period to kill harmful bacteria and pathogens while preserving the product's quality and shelf life. In some embodiments, during pasteurization, the pre-pasteurization fluid is heated to about 85-95° C. (185-203° F.) to pasteurize it. In some embodiments, pasteurization helps kill any harmful bacteria present in the milk while also denaturing proteins to improve the yogurt's texture. In some embodiments, after heating, the fluid is cooled to around 40-45° C. (104-113° F.) in preparation for a fermentation process. In some embodiments, the fortified fluid is rapidly cooled to the desired temperature to halt any further microbial growth and maintain product stability. In some embodiments, the fluid may then be stored temporarily before further processing.

In some embodiments, to ferment the fluid, the yogurt starter culture is added to the cooled fluid. In some embodiments, the starter culture contains live bacteria that ferments the milk in the fluid and converts the milk into yogurt. In some embodiments, yogurt with live active cultures may be used as a starter, or freeze-dried cultures specifically designed for yogurt making may be used.

In some embodiments, the starter culture may be mixed into the cooled fluid thoroughly. In some embodiments, the fluid may be kept at a consistent temperature throughout fermentation, ideally around 40-45° C. (104-113° F.), to encourage the growth of the bacteria. In some embodiments, this incubation period lasts for about 4 to about 12 hours, depending on the desired thickness and tanginess of the yogurt. During fermentation, when using milk, the bacteria may ferment lactose in the milk, producing lactic acid, lowering the pH of the mixture, and thickening the fluid into yogurt. Once the yogurt has reached the desired consistency and tanginess, the yoghurt may be removed from the incubation environment and cooled rapidly to halt the fermentation process.

In some embodiments, following the production of yogurt, the yoghurt may be stored in, for example, stainless steel tanks for up to 24 hours.

In some embodiments, production of dehydrated yogurt mass from yoghurt requires utilization of mechanical devices capable of generating sufficient force to separate whey from the yogurt. In some embodiments, these devices include various dairy separators, decanter centrifuges, cheese presses employing both vertical and horizontal actions, as well as fruit and vegetable juice presses. In some embodiments, equipment such as cheese presses, which utilize both vertical and horizontal actions, and fruit and vegetable juice presses necessitate the use of filtering mediums, such as disposable or multiuse paper, fabric, plastic, metal mesh, or composite material bags or filters.

In some embodiments, the yoghurt is reduced to a temperature of about 60° F. or less prior to filtering dehydration. In a first method for forming a dehydrated yoghurt mass, the cooled yoghurt may be subjected to one or more filtering mediums to remove excess whey. In some embodiments, straining equipment, centrifuges, or specialized filtration systems such as those listed above may be used. From the one or more filtering mediums, the cooled yoghurt may be transferred to one or more cheese presses (and/or fruit, vegetable, or cider presses) that utilize both vertical and horizontal actions. In some embodiments, the yoghurt is processed within the cheese presses for about 8 hours to about 18 hours at a pressure of about 1 Bar to about 10 Bar. In some embodiments, the vertical action of the cheese press involves applying downward pressure directly onto the yoghurt. This vertical pressure compresses the yoghurt, expelling whey and helping to shape the yoghurt into a solid mass. In some embodiments, horizontal action is also utilized, which comprises applying pressure from the sides or ends of the yoghurt, exerting lateral force on the mass. This helps to further compress the yoghurt, expel additional whey, and ensure uniform shaping of the yoghurt.

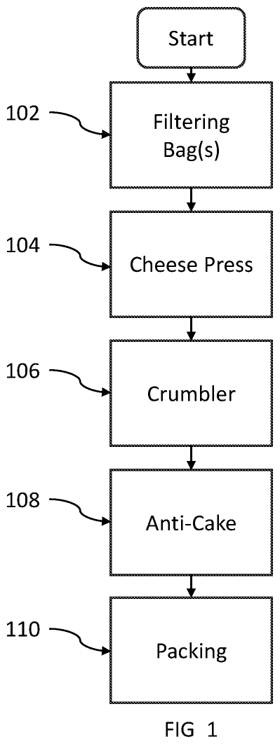

FIG. 1 illustrates a diagram of an example filter bag dehydrating process according to some embodiments herein. In some embodiments, at 102, yogurt may be fed into one or more filtering bags. In some embodiments, one or more filtering bags of varied sizes, materials, and/or meshes could be used. In some embodiments, at 104, the bags are placed into cheese/curd presses and kept in the presses under pressure until solid content of the yoghurt reaches about 40%. Thereafter, at 106, the dehydrated yogurt is moved to a cheese crumbler or a cheese shredder to produce yoghurt crumbles having diameters between about ⅛ inch to about ¾ inch. A cheese crumbler is a machine used in the cheese-making industry to break down solid cheese blocks or wheels into smaller crumbled pieces. A cheese crumbler typically consists of a rotating drum or cylinder with blades or teeth that shred or cut the cheese into smaller fragments. According to some embodiments herein, cheese crumblers are adapted for use with yogurt. At 108, the crumbles are conveyed to an anti-caking station where anti-caking agent is added. Anti-caking agents are substances added to prevent the formation of lumps or clumps caused by moisture absorption or chemical reactions. In some embodiments, anti-caking agents are used to prevent the yogurt from clumping together during processing, storage, and/or packaging. In some embodiments, the anti-caking agent(s) may comprise silicon dioxide (silica), calcium silicate, magnesium stearate, sodium aluminosilicate, and tricalcium phosphate. After anti-caking, at 110, the crumbles are conveyed to filling and packaging machines. In some embodiments, the method of FIG. 1 may be utilized with non-fat, full fat, or low fat yoghurt.

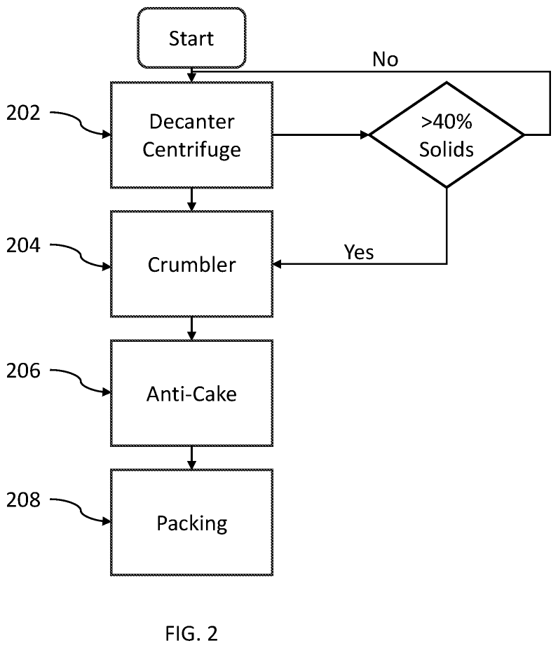

FIG. 2 illustrates a diagram of an example decanter centrifugal dehydrating process according to some embodiments herein. In some embodiments, at 202, yogurt is fed into one or more food certified decanter centrifuges to remove liquid from the yoghurt. In some embodiments, the yoghurt may move through the one or more food certified decanter centrifuges in about 20 sec to about 30 sec. In some embodiments, the yoghurt may be fed to the centrifuge(s) at about 60° F. to about 115° F. The bowl speed of the centrifuges may be about 2500 rpm to about 4900 rpm and held at a pressure of about 1 Bar to about 2 Bar, and with a scroll speed of about 2 rpm to about 5 rpm. In some embodiments, once the yoghurt has been cycled through the centrifuge(s), the solids content of the yoghurt is measured. If the solid content of the yoghurt is less than 40%, the yoghurt may be re-cycled through the centrifuges as many times as necessary until the solid content of the yoghurt reaches 40%. The determination of total solids is preferably performed as described in International Organization for Standardization (ISO) 6731:2010 (IDF 21:2010) Milk, cream, and evaporated milk-Determination of total solids content (Reference method). Thereafter, at 204, the dehydrated yogurt is moved to cheese crumbler or a cheese shredder to produce the yoghurt crumbles. In some embodiments, at 206, the crumbles are conveyed to an anti-caking station where anti-caking agent is added to the dehydrated yoghurt. In some embodiments, at 208, the crumbles are conveyed to filling and packaging machines for packaging. In some embodiments, preferably the method of FIG. 2 is utilized to process non-fat milk dehydrated yoghurt mass. Decanter centrifuges are efficient in separating non-fat solids from whey but are generally not suitable for effectively processing milk with fat content. Thus, in some embodiments, preferably, non-fat (skim) milk yoghurt undergoes dehydration using decanter centrifuges.

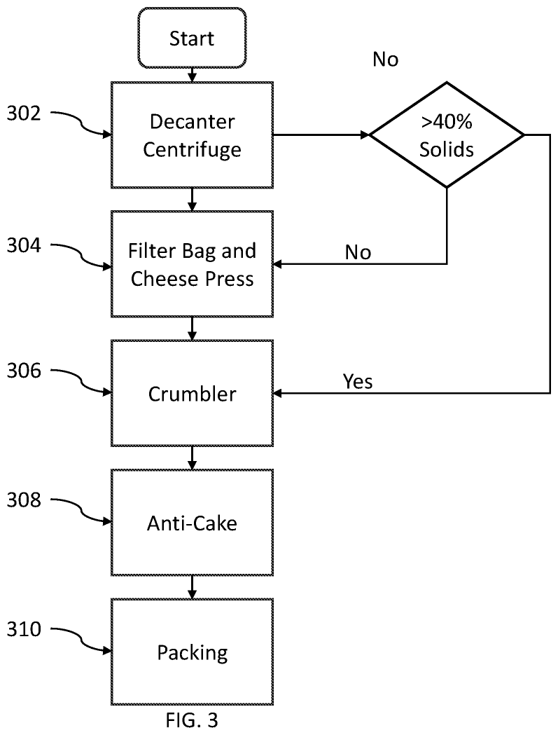

FIG. 3 illustrates a diagram of an example decanter centrifugal dehydrating process and supplemental bag pressing process according to some embodiments herein. In some embodiments, at 302, yogurt is fed into one or more food certified decanter centrifuges to remove liquid from the yoghurt. In some embodiments, the yoghurt may be fed to the centrifuge(s) at about 60° F. to about 115° F. The bowl speed of the centrifuges may be about 2500 rpm to about 4900 rpm and held at a pressure of about 1 Bar to about 2 Bar, and with a scroll speed of about 2 rpm to about 5 rpm. In some embodiments, once the yoghurt has been cycled through the centrifuge(s), the solids content of the yoghurt is measured. In some embodiments, at 304, if the solid content of the yoghurt is less than 40%, the yoghurt may be conveyed to filtering bags (as described with respect to FIG. 1) and pressed in a cheese/curd press until the yoghurt reaches a solid content at least 40% total solids. Thereafter, at 306, the dehydrated yogurt is moved either directly from the centrifuges or from the or from the cheese press to a cheese crumbler or a cheese shredder to produce the yoghurt crumbles. In some embodiments, at 308, the crumbles are conveyed to an anti-caking station where anti-caking agent is added. In some embodiments, at 310, the crumbles are conveyed to filling and packaging machines for packaging. In some embodiments, preferably the method of FIG. 3 is utilized to process non-fat milk dehydrated yoghurt mass. In some embodiments, when utilizing the methods of FIG. 2 or FIG. 3, a supplemental fat source may be added to the yoghurt after dehydration/centrifuging. For example, in some embodiments, butterfat and/or butter may be added as a supplemental fat source.

### Additional Embodiments

Conditional language used herein, such as, among others, “can,” “could,” “might,” “may,” “e.g.,” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or that one or more configurations necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain configurations require the presence of at least one of X, at least one of Y, and at least one of Z.

While the above detailed description may have shown, described, and pointed out novel features as applied to various configurations, it may be understood that various omissions, substitutions, and/or changes in the form and details of any particular configuration may be made without departing from the spirit of the disclosure. As may be recognized, certain configurations may be embodied within a form that does not provide all of the features and benefits set forth herein, as some features may be used or practiced separately from others.

Additionally, features described in connection with one configuration can be incorporated into another of the disclosed configurations, even if not expressly discussed herein, and configurations having the combination of features still fall within the scope of the disclosure. For example, features described above in connection with one configuration can be used with a different configuration described herein and the combination still falls within the scope of the disclosure.

It should be understood that various features and aspects of the disclosed configurations can be combined with, or substituted for, one another in order to form varying modes of the configurations of the disclosure. Thus, it is intended that the scope of the disclosure herein should not be limited by the particular configurations described above. Accordingly, unless otherwise stated, or unless clearly incompatible, each configuration of this disclosure may comprise, additional to its essential features described herein, one or more features as described herein from each other configuration disclosed herein.

Features, materials, characteristics, or groups described in conjunction with a particular aspect, configuration, or example are to be understood to be applicable to any other aspect, configuration or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing configurations. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some configurations, the actual steps taken in the processes illustrated and/or disclosed may differ from those shown in the figures. Depending on the configuration, certain of the steps described above may be removed, others may be added.

Furthermore, the features and attributes of the specific configurations disclosed above may be combined in diverse ways to form additional configurations, all of which fall within the scope of the present disclosure. Also, the separation of various system components in the implementations described above should not be understood as requiring such separation in all implementations, and it should be understood that the described components and systems can generally be integrated together in a solitary product or packaged into multiple products.

For purposes of this disclosure, certain aspects, advantages, and novel features are described herein. Not necessarily all such advantages may be achieved in accordance with any particular configuration. Thus, for example, those skilled in the art will recognize that the disclosure may be embodied or conducted in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain configurations, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred configurations in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise,” “comprising,” and the like, are to be construed in an inclusive sense as opposed to an exclusive or exhaustive sense, which is to say, in the sense of “including, but not limited to.”

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred configurations described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. A yoghurt composition comprising:
dehydrated whole milk, low-fat, or non-fat yoghurt comprising at least 40% solids by weight and at least 20% protein by weight,
wherein the dehydrated yoghurt is formed into crumbles that have a solid texture, wherein at least 85% of the crumbles comprise a diameter between about 0.125 inch to about 0.750 inch.

2. The yoghurt composition of claim 1, wherein the dehydrated yoghurt comprises Streptococcus salivarius thermophilus and/or Lactobacillus delbruekii subsp. Bulgaricus.

3. The yoghurt composition of claim 1, further comprising a flavor component comprising at least one of the following: vanilla, strawberry, blueberry, raspberry, peach, mango, coconut, lemon, lime, cherry, banana, apple, pineapple, orange, blackberry, cranberry, pomegranate, passion fruit, kiwi, grape, watermelon, honeydew, cantaloupe, apricot, fig, plum, grapefruit, guava, lychee, papaya, elderberry, boysenberry, loganberry, mulberry, tangerine, mandarin, nectarine, pear, star fruit, persimmon, dragon fruit, durian, melon, pumpkin, squash, sweet potato, yam, carrot, beetroot, parsnip, radish, turnip, rutabaga, kohlrabi, celery, fennel, leek, onion, shallot, garlic, chive, scallion, mushroom, truffle, bell pepper, chili pepper, jalapeño, habanero, cayenne, paprika, black pepper, white pepper, green pepper, red pepper, yellow pepper, orange pepper, pink pepper, lemon pepper, lime pepper, peppercorn, mustard, Dijon mustard, wholegrain mustard, honey mustard, spicy mustard, horseradish, wasabi, ginger, cinnamon, nutmeg, clove, allspice, cardamom, star anise, chocolate, cocoa, coffee, caramel, toffee, butterscotch, maple, honey, molasses, agave, almond, hazelnut, pecan, walnut, cashew, macadamia, pistachio, peanut, sesame, sunflower, pumpkin seed, flaxseed, chia seed, poppy seed, quinoa, amaranth, millet, barley, oats, rye, spelt, wheat, rice, corn, sorghum, teff, buckwheat, lentil, chickpea, pea, bean, mung bean, kidney bean, black bean, soybean, tofu, tempeh, miso, natto, seaweed, nori, wakame, kombu, hijiki, dulse, spirulina, chlorella, agar, konjac, psyllium, xanthan gum, guar gum, carrageenan, pectin, gelatin, bee pollen, royal jelly, propolis, bee venom, honeycomb, and beeswax.

4. The yoghurt composition of claim 1, further comprising at least one of the following functional ingredients: collagen, whey protein, casein protein, pea protein, hemp protein, rice protein, pumpkin protein, cricket protein, insect protein, mealworm protein, ant protein, probiotics, prebiotics, fiber, omega-3 fatty acids, antioxidants, vitamins, minerals, calcium, potassium, magnesium, iron, zinc, selenium, vitamin A, vitamin C, vitamin D, vitamin E, vitamin K, vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folate), vitamin B12 (cobalamin), electrolytes, amino acids, protein, carbohydrates, fat, cholesterol, lactose, casein, whey, lactalbumin, lactoglobulin, immunoglobulins, lactoferrin, lactoperoxidase, lysozyme, lactulose, lactitol, lactase, lactase enzyme, lactase prebiotic, lactase probiotic, lactase supplement, lactoferrin supplement, inulin, fructooligosaccharides (FOS), galactooligosaccharides (GOS), resistant starch, arabinoxylan, beta-glucans, chitin, chitosan, psyllium, and oat fiber.

5. The yoghurt composition of claim 1, wherein the dehydrated yoghurt comprises dehydrated whole milk yogurt, wherein the whole milk yoghurt comprises a fat content of at least 3.5%, and a pH of 4.8 or less.

6. The yoghurt composition of claim 1, wherein the dehydrated yoghurt comprises dehydrated low-fat or non-fat yoghurt, wherein the low-fat or non-fat yoghurt comprises a fat content of less than 3.5%, and a pH of 4.8 or less.

7. A method of manufacturing a yoghurt composition, the method comprising:
feeding whole milk, low-fat, or non-fat yoghurt into a filtering bag;
placing the filtering bag into a cheese press and applying pressure to the filtering bag until a solid content of the yoghurt is at least 40% to form dehydrated yoghurt;
processing the dehydrated yogurt in a cheese crumbler or a cheese shredder to produce dehydrated yoghurt crumbles; and
applying an anti-caking agent to the dehydrated yoghurt crumbles.

8. The method of claim 7, wherein the anti-caking agent comprises silicon dioxide (silica), calcium silicate, magnesium stearate, sodium aluminosilicate, or tricalcium phosphate.

9. The method of claim 7, wherein the yoghurt comprises whole milk yogurt, wherein the whole milk yoghurt comprises a fat content of at least 3.5%, and a pH of 4.8 or less.

10. The method of claim 7, wherein the yoghurt comprises low-fat or non-fat yoghurt, wherein the low-fat or non-fat yoghurt comprises a fat content of less than 3.5%, and a pH of 4.8 or less.

11. The method of claim 7, further comprising adding one or more of a flavor component, a functional ingredient, and/or a supplemental fat source to the yoghurt.

12. The method of claim 7, wherein the pressure is applied to the filtering bag in the cheese press for about 8 hours to about 18 hours at a pressure of about 1 Bar to about 10 Bar.

13. A method of manufacturing a non-fat yoghurt composition, the method comprising:
feeding non-fat yoghurt into a food certified decanter centrifuge at a temperature of about 60° F. to about 115° F.;
centrifuging the non-fat yoghurt at a bowl speed of about 2500 rpm to about 4900 rpm and a pressure of about 1 Bar to about 2 Bar until a solid content of the non-fat yoghurt is at least 40% by weight to form dehydrated non-fat yoghurt;
processing the dehydrated non-fat yogurt in a cheese crumbler or a cheese shredder to produce dehydrated non-fat yoghurt crumbles; and
applying an anti-caking agent to the dehydrated yoghurt crumbles.

14. The method of claim 13, wherein the anti-caking agent comprises silicon dioxide (silica), calcium silicate, magnesium stearate, sodium aluminosilicate, or tricalcium phosphate.

15. The method of claim 13, wherein the non-fat yoghurt comprises a fat content of less than 3.5%, and a pH of 4.8 or less.

16. The method of claim 13, further comprising adding one or more of a flavor component, a functional ingredient, and/or a supplemental fat source to the yoghurt.

17. A method of manufacturing a yoghurt composition, the method comprising:
feeding yoghurt into a food certified decanter centrifuge at a temperature of about 60° F. to about 115° F.;
centrifuging the yoghurt at a bowl speed of about 2500 rpm to about 4900 rpm and a pressure of about 1 Bar to about 2 Bar;
measuring a solid content of the yoghurt after a predetermined period of time;
if the solid content of the yoghurt is less than 40% by weight, feeding the yoghurt into a filtering bag;
placing the filtering bag into a cheese press and applying pressure to the filtering bag until a solid content of the yoghurt is at least 40% to form dehydrated yoghurt;
processing the dehydrated yogurt in a cheese crumbler or a cheese shredder to produce dehydrated yoghurt crumbles; and
applying an anti-caking agent to the dehydrated yoghurt crumbles.

18. The method of claim 17, wherein the yoghurt comprises non-fat yoghurt, wherein the non-fat yoghurt comprises a fat content of less than 3.5%, and a pH of 4.8 or less.

19. The method of claim 17, wherein the anti-caking agent comprises silicon dioxide (silica), calcium silicate, magnesium stearate, sodium aluminosilicate, or tricalcium phosphate.

20. The method of claim 17, further comprising adding one or more of a flavor component, a functional ingredient, and/or a supplemental fat source to the yoghurt.
